(19) United States
(12) Patent Application Publication
(10) Pub. No.: US 2015/0116370 A1
(43) Pub. Date: Apr. 30, 2015

(54) METHOD FOR SUCCESSIVELY DISPLAYING SECTIONS OF SCREEN AND COMPUTER-READABLE MEDIUM

(71) Applicant: VIVOTEK INC., New Taipei (TW)

(72) Inventor: Shih-Wu FAN JIANG, New Taipei (TW)

(21) Appl. No.: 14/500,040

(22) Filed: Sep. 29, 2014

(30) Foreign Application Priority Data
Oct. 30, 2013 (TW) 102139334

(51) Int. Cl. G06T 3/20; G09G 5/18

(52) U.S. Cl. CPC G06T 3/20; G09G 5/18
USPC 345/682

(57) ABSTRACT

Disclosed herein are a method for successively displaying sections of a screen and a corresponding computer-readable medium. The method comprises loading the screen, transforming a section of the screen to which a starting point on the screen corresponds into a starting sub-screen, transforming a section of the screen to which a selected ending point on the screen corresponds into an ending sub-screen, and transforming sections of the screen to which a selected plurality of midway points on the screen correspond into midway sub-screens. The points collectively correspond to a time sequence, based on which the sub-screens are sequentially displayed. The present invention enables digital mechanisms that capture and sequentially display parts of a wide-angle image to approximate the shifting motion of the human eye or mechanical PTZ cameras in response to changing observing angles of view.

### CROSS-REFERENCE TO RELATED APPLICATIONS

This non-provisional application claims priority under 35 U.S.C. §119(a) on Patent Application No. 102139334 filed in Taiwan, R.O.C. on the thirtieth of October 2013, the entire contents of which are hereby incorporated by reference.

### TECHNICAL FIELD

The present invention pertains to image processing.

### BACKGROUND

As its name suggests, a pan-tilt-zoom (PTZ) camera, capable of triaxial movement, lets one lock on in a general scene the view from a certain observing angle of view, and is far better in terms of surveillance than a conventional immobile camera. Realization of PTZ may be purely mechanical; that is, the camera rotates horizontally and vertically on, say, a pan-tilt head, and inside the camera there are lens elements capable of optical zoom. There is also a class of electronic PTZ (ePTZ) cameras, whose lens is non-rotatable but captures wide-angle images, sections of which can be extracted, and digitally zoomed or dewarp optionally to achieve PTZ. ePTZ is cheap, fast, and multi-plexes real-time streams, but it being a simulation, user experience therewith is never as natural as mechanical PTZ. For instance, when one changes the observing angle of view in a wide-angle image (means changing the position of the section in the wide-angle image), ePTZ often cuts abruptly to the new view without allowing for the fact that a real PTZ camera needs time to adjust or turn its lens. Similarly, transition signifying virtual displacement or turnaround in a holographic image of Google Street View is accomplished through stretching the destination image, and is quite different from what a human being experiences in an actual stroll.

### SUMMARY

In light of the above, the present invention discloses a method for successively displaying sections of a screen and a corresponding computer-readable medium. Here a screen, or a view, is taken to mean displayable visual data. The method is applicable to ePTZ or other digital mechanisms that extract from wide-angle screens and display sections thereof, so that the sections are successively displayed in a manner that approximates the shifting motion of the human eye or mechanical PTZ cameras in response to changing observing angles of view, user experience improved, and merits of digital mechanisms kept.

In the method disclosed, the screen, which has a coordinate system, is loaded. Based on a starting point in the coordinate system, a section of the screen to which the starting point corresponds is transformed into a starting sub-screen. An ending point is selected in the coordinate system. Another section of the screen to which the ending point corresponds is transformed into an ending sub-screen. A plurality of midway points are selected in the coordinate system. Sections of the screen to which the midway points correspond are respectively transformed into a plurality of midway sub-screens. The points collectively correspond to a time sequence, based on which the sub-screens are sequentially displayed.

The computer-readable medium disclosed has program code for causing a processor to execute the method above as a plurality of instructions.

In short, the midway points are selected between the starting point and the ending point, two observing angles of view of the screen, and an animation results from displaying the sections of the screen to which the points respectively correspond. Consequently, the method and computer-readable medium disclosed enables ePTZ or other digital mechanisms to simulate the continuous shifting motion of the human eye or mechanical PTZ cameras and thus improve user experience. What is more, the screen and the sub-screens may have different characteristics or be displayed concurrently in embodiments of the present invention. The sub-screens may have different resolutions, and the correspondence of the points and the time sequence may form an arbitrary function.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a flowchart of a method for successively displaying sections of a screen, in accordance with an embodiment of the present invention;

FIG. 2 illustrates a screen and a sub-screen, in accordance with an embodiment of the present invention;

FIG. 3 depicts an easing curve according to an embodiment of the present invention; and

FIG. 4 illustrates selecting midway points based on an easing curve and displaying midway sub-screens, in accordance with an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

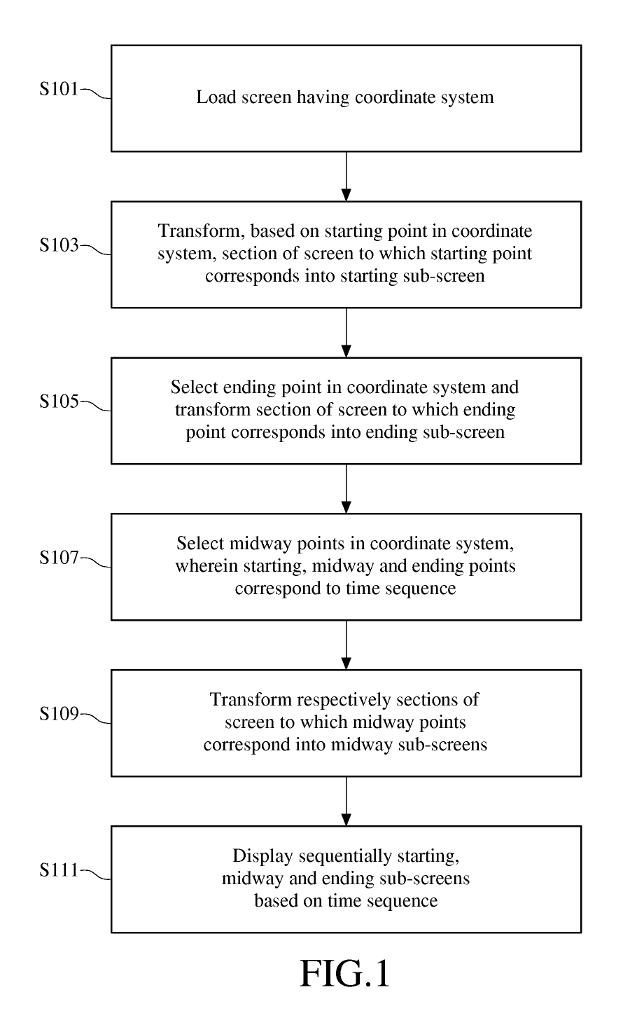

Please refer to FIG. 1. As shown in the flowchart, a screen is loaded in step S101. In order that a user be able to change the observing angle of view in the screen, the screen has a coordinate system that indexes observable points thereon. In step S103, a section of the screen corresponding to a point in the coordinate system that is taken as the start of a successive display is transformed into a starting sub-screen. The present invention does not restrict how the starting point or any other point correspond to the screen. For example, the starting point may correspond to a rectangular or polygonal region of the screen that centers around the starting point, or the starting point may be in the top-left corner of the region, while the size of the region may be decided by the user.

In general, the screen is a global view and shows a relatively large scene or field, whereas sub-screens (including said starting sub-screen) represent relatively small regions of interest (ROI). In some embodiments, the screen has a first characteristic, which may signify that the screen is a wide-angle image and may be captured by a fisheye lens and thus somewhat curvilinear. Meanwhile, a sub-screen may have a second characteristic, which may signify that the sub-screen is rectilinear. In these embodiments, the transformation of a section of the screen into a sub-screen may be a type of distortion correction of curvilinear imagery. Please note that the present invention is not restrictive with regard to the first and second characteristics and the transformation. In other embodiments, the transformation may include only cropping the screen without any correction, or the screen and a sub-screen are distinguished not by linearity, but by dimensionally different fields of view.

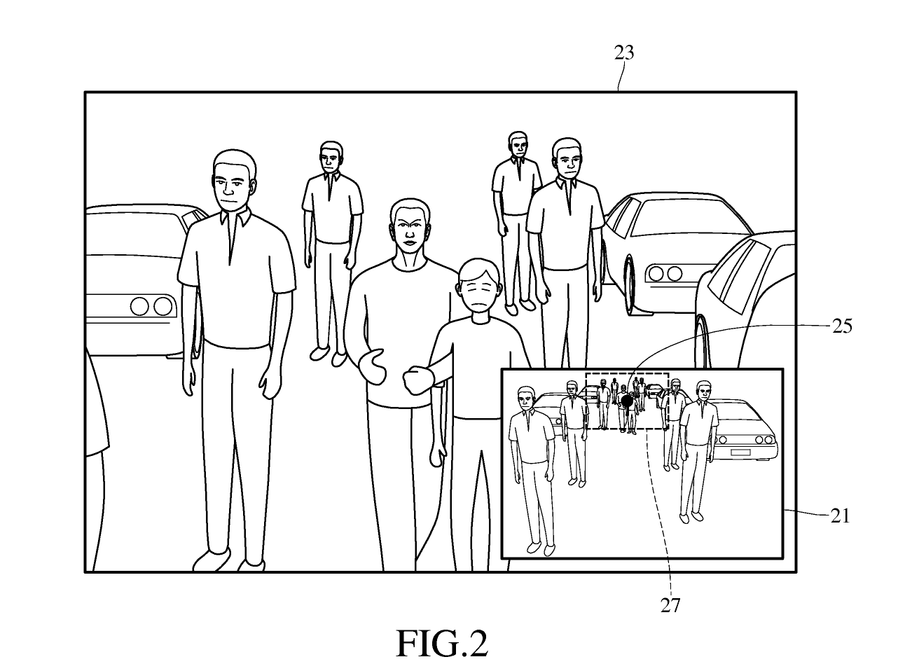

An apparatus or a piece of software implementing the present invention may cut to a ROI once started, so as to provide a sub-screen that does not correspond to the starting point. This echoes step S105 in FIG. 1: selecting an ending point in the coordinate system of the screen, and transforming a section of the screen to which the ending point corresponds into an ending sub-screen. Same as said starting point, the ending point is not restricted in the present invention as to its correspondence with the screen. As shown in FIG. 2, the section of the screen 21 to which the ending point 25 corresponds may be a rectangular or polygonal ROI 27 centered around the ending point 25, and the size of the ROI 27 may be decided by the user. The ending point 25 may as well be located in the top-left corner of the ROI 27 in another embodiment. As in FIG. 2, the apparatus or software implementing the present invention may concurrently provide the screen 21 and the ending sub-screen 23 as the main of its default display; that is, the screen 21 may be reduced to a corner of the display, and the user clicks on the screen 21 with an input device to specify the ending point 25. In addition, the size of the ending sub-screen 23 or the ROI 27, besides being determined by the implementing apparatus or software, may be generated by the user clicking on the ending point 25 and dragging away. The generated ROI 27 may as well be marked on the screen 21. Besides being selected on the screen 21, the ending point 25 may as well be manually input by the user, or generated by the implementing apparatus or software.

In steps S107 and S109 of FIG. 1, then, a plurality of midway points are selected, and sections of the screen respectively corresponding to these midway points are transformed into a series of midway sub-screens. Here the selection and transformation are similar to those in generating the ending point and the ending sub-screen. The midway points obviously form in the coordinate system of the screen a path that has the starting and ending points as both ends. The present invention does not restrict whether this path is bent or straight, how long it is, nor restricts the number of midway points or where they might be on the screen. Should the screen be curvilinear but have a rectilinear coordinate system, selecting a bent path could be more in line with the shifting motion of a PTZ camera changing observing angles of view or a turning human head.

Most importantly, the starting, midway, and ending points correspond to a time sequence based on an easing curve. The time sequence indicates how the starting, midway, and ending sub-screens are sequentially displayed in step S111 of FIG. 1, namely while the observing angle of view to or the ROI on the screen is being changed. The easing curve indicates how to select the midway points in the time sequence, and how fast the shifting of corresponding scenes is while the observing angle of view to the screen is being changed. In the present invention, when the easing curve ‘eases out’ or is mathematically convex, the distance between adjacent midway points gradually decreases and there is less and less difference from one midway sub-screen to the next; in other words, the scenes are shifted increasingly slow. When the easing curve ‘eases in’ or is mathematically concave, the distance between adjacent midway points gradually increases and there is more and more difference from one midway sub-screen to the next; in other words, the scenes are shifted increasingly fast. The easing curve may have arbitrary appearance. In practice, the easing curve may be linear or may be smooth like a cubic polynomial, according to the discretion of any person skilled in the art.

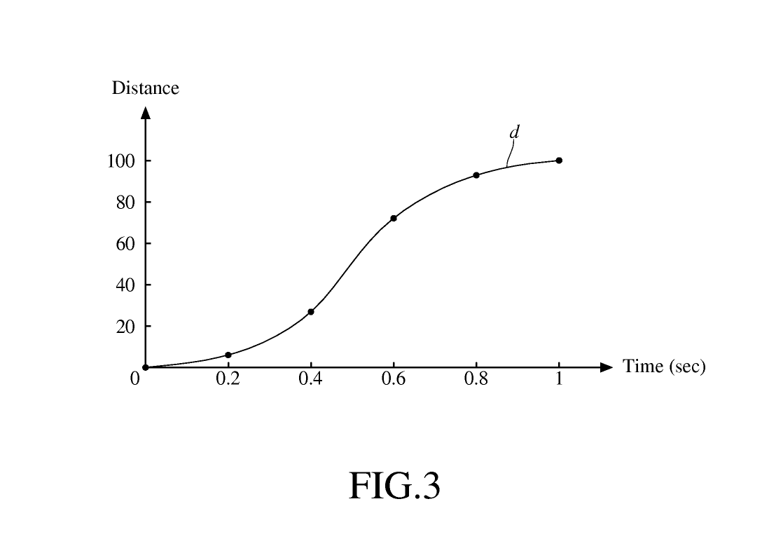

Generally speaking, one or more easing curves are applied to the coordinates in order to select the midway points. Please refer to FIG. 3, which is based on an embodiment where one easing curve d is applied to both x- and y-axes of the two-dimensional space, and where the unit of distance is the same for both of those axes. In FIG. 3, the horizontal axis signifies time, and the vertical axis is distance of various points relative to the starting point. A time sequence recorded as (0.0, 0.2, 0.4, 0.6, 0.8, 1.0) may express the fact that the apparatus or software implementing the present invention displays the default starting sub-screen when starting (0.0 second), the first midway sub-screen at 0.2 second, the second midway sub-screen at 0.4 second, and so on until 1.0 second when the ending sub-screen is displayed to complete the changing of observing angles of view and becomes the starting sub-screen next time the observing angle of view changes. There are five sub-screens to be displayed in this example, not counting the starting one. The easing curve d signifies the distances of each midway point and the ending point relative to the starting point; d(0.2)=10, for instance, is the distance between the starting point and the midway point corresponding to the first midway sub-screen, d(0.4)=20 is that between the starting point and the midway point corresponding to the second midway sub-screen, and so on until d(1.0)=100 is the distance of the ending point relative to the starting point. The correspondence of the distances and the time sequence, expressed as a function, becomes the piecewise linear easing curve d in FIG. 3 that ‘eases in-out’ and is applied to both the x- and y-axes, and based on which the path of the selected midway points are determined. Assuming that the screen and the midway sub-screens are not distinguishable by linearity, then the path formed by the midway points on the screen is a straight line when the same easing curve is applied to both the x- and y-axes, and a general curve when different easing curves are applied.

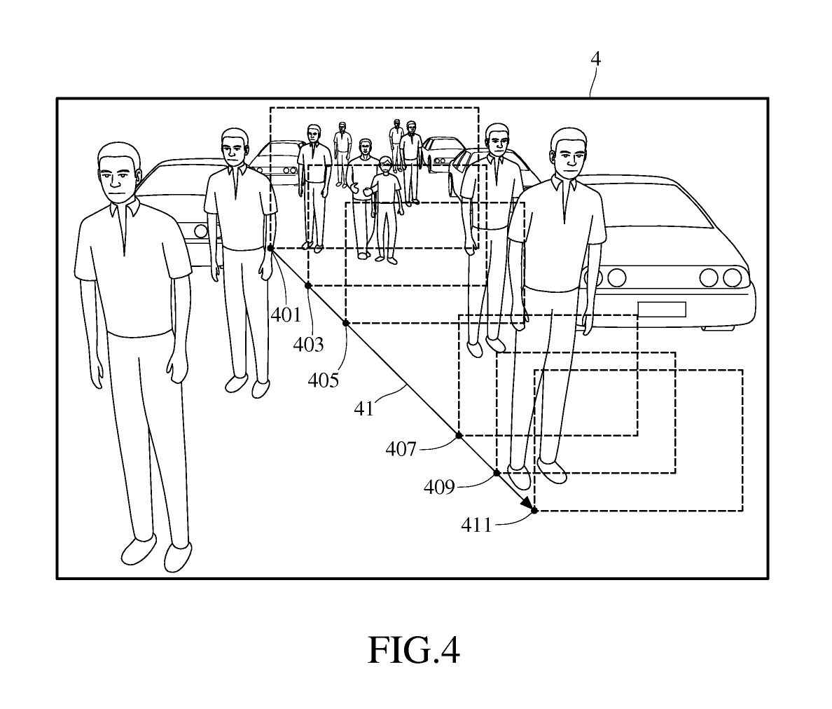

Please refer to FIG. 4, which illustrates selecting the midway points and displaying the midway sub-screens based on the easing curve d of FIG. 3. As shown in FIG. 4, the starting point 401, the midway points 403, 405, 407, 409, and the ending point 411 form the path 41 on the screen 4. The dashed-line frame beside (or in whose bottom-left corner is) the starting point 401 represents the section of the screen 4 to which the starting point 401 corresponds, and similarly are represented the sections of the screen 4 to which the other points correspond. The easing curve d expresses the fact that sectional scenes of the screen are first shifted slowly, then fast, and then slow again. Specifically, when the observing angle of view starts shifting, the apparatus or software implementing the present invention spends 0.2 second to move by 10 units of distance from the midway point 403 (displaying the first midway sub-screen) along the path 41 to the midway point 405 (displaying the second midway sub-screen), and spends another 0.2 second to move by the same distance from the midway point 407 (displaying the third midway sub-screen) along the path 41 to the midway point 409 (displaying the fourth midway sub-screen), but moves by 60 units of distance from the midway point 405 to 407 in the same amount of time, wherein the path 41 is a straight line.

The time sequence to which the points correspond typically has a plurality of equally separated time points. In other words, the frame rate for displaying the sub-screens is fixed. In a preferred embodiment, the continuous shifting motion of the human eye or mechanical PTZ cameras is satisfactorily simulated when said frame rate is about 30 sub-screens per second. If in addition the time for changing the observing angles of view is predefined to 1 second in this embodiment, then about 30 points need to be selected and corresponding sub-screens transformed into, with each of the sub-screens being displayed for the same amount of time, i.e. about one thirtieth of a second.

Please note that although in practice the dimensions of the sub-screens for display are fixed, the sub-screens may not have the same resolution. The starting and ending sub-screens may have identical or different resolutions. The resolution of a midway sub-screen may be the same as that of the starting sub-screen or as that of the ending sub-screen. When the starting and ending sub-screens have different resolutions, those of the midway sub-screens may gradually vary, so that the resolutions of the first midway sub-screen and the starting sub-screen are alike, and those of the last midway sub-screen and the ending sub-screen are alike. Specifically, assuming that the resolution of the starting sub-screen is 160 pixels by 120 pixels (the units shall be omitted hereinafter), that of the ending sub-screen is 320 by 240, and that 30 midway sub-screens are selected and transformed, then it may be that the resolution of each midway sub-screen is on average (320-160)÷30 =5.3 pixels wider and (240-120)÷30 =4 pixels taller (as in height) than that of the previous sub-screen. Without regard to sub-pixels, this implies that the first midway sub-screen has a resolution of 165 by 124, the second has a resolution of 171 by 128, and so on. Further assuming that the dimensions of the sub-screens for display are fixed to 640 by 480, the starting and ending sub-screens are enlarged 4 and 2 times, respectively, both width- and height-wise when displayed, and the 30 midway sub-screens are enlarged each according to their resolutions. In this example, the user is shown a motion picture of fixed size but becomes clearer as the starting, midway, and ending sub-screens are successively displayed.

Said screen may be a frame sequence instead of a single image, and the sub-screens are transformed from various frames therein. Suppose for instance that the implementing apparatus or software is connected with an ePTZ camera which captures wide-angle images at 30 frames per second; that is, the capturing frame rate is 30 wide-angle images per second. Further assuming that the frame rate for displaying the sub-screens is predefined to 30 per second as well and the time for changing the observing angles of view is predefined to 1 second, then the starting sub-screen is transformed from the first wide-angle image, the first midway sub-screen is transformed from the second wide-angle image, the second midway sub-screen is transformed from the third wide-angle image, and so on until the ending sub-screen is transformed from the thirtieth wide-angle image. Assuming otherwise that the sub-screens displaying frame rate is 60 per second, then the first and second sub-screens (the starting and the first midway ones) are transformed from the first wide-angle image, the third and fourth sub-screens from the second wide-angle image, and so on. Assuming still otherwise that neither the frame rate for displaying the sub-screens nor the capturing frame rate is divisible by the other, then upon transforming at some point in time ‘a section of the screen’ corresponding to a midway point, the displayed midway sub-screen may come from the most recently obtained wide-angle image or the temporally closer one of two successive wide-angle images. Please note that in said embodiments parameters such as the image capturing frame rate, the sub-screen displaying frame rate, and the observing-angle of view changing time may respectively be customized to the user's preference or default values put forth by the apparatus or software implementing the present invention.

To conclude, the present invention of a method for successively displaying sections of a screen or global view and a corresponding computer-readable medium simulates by animation the shifting motion of the human eye or mechanical PTZ cameras in response to changing observing angles of view and thus improves user experience. In the present invention, a plurality of midway points are selected in the coordinate system of the screen, and sections of the screen corresponding thereto, along with those to which starting and ending points correspond, are displayed based on a time sequence, wherein the correspondence of the points and the time sequence form a linear or non-linear easing curve. In one embodiment, at least part of the screen can be displayed alongside a sub-screen, albeit less prominently, for indexing the ending point. In another, the wide-angle screen is in contrast with the sub-screens, whose rectilinearity arises from performing distortion correction on the sections of the screen. In other embodiments, the sub-screens may have identical or different resolutions, or the screen may be a frame sequence composed of a plurality of images.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A method for successively displaying sections of a screen, the method comprising:
loading the screen, the screen having a coordinate system;
transforming, based on a starting point in the coordinate system, a section of the screen to which the starting point corresponds into a starting sub-screen;
selecting an ending point in the coordinate system, and transforming a section of the screen to which the ending point corresponds into an ending sub-screen;
selecting a plurality of midway points in the coordinate system, wherein the starting point, the midway points, and the ending point correspond to a time sequence;
transforming respectively sections of the screen to which the midway points correspond into a plurality of midway sub-screens; and
displaying sequentially the starting sub-screen, the midway sub-screens, and the ending sub-screen based on the time sequence.

2. The method of claim 1, wherein part or all of the screen is displayed concurrently with the starting sub-screen, the midway sub-screens, and the ending sub-screen being sequentially displayed.

3. The method of claim 2, wherein the starting sub-screen has a first resolution and the ending sub-screen has a second resolution.

4. The method of claim 1, wherein the screen has a first characteristic, and the starting sub-screen, the midway sub-screens, and the ending sub-screen have a second characteristic, wherein having the first characteristic is being wide-angle, having the second characteristic is being rectilinear, and the second characteristic arises from performing distortion correction of curvilinear imagery on the sections of the screen to which the starting point, the midway points, and the ending point respectively correspond.

5. The method of claim 1, wherein the time sequence has a plurality of time points, there is a fixed interval between any adjacent pair of the time points, and each of the starting point, the midway points, and the ending point corresponds to one of the time points.

6. The method of claim 1, wherein the screen includes a plurality of successive images of an identical field of view, and the starting sub-screen, the midway sub-screens, and the ending sub-screen respectively correspond to sections of the successive images of the screen.

7. The method of claim 1, wherein the starting point, the midway points, and the ending point correspond to the time sequence based on an easing curve.

8. A computer-readable medium having program code for causing a processor to execute a plurality of instructions, the instructions comprising:
loading a screen, the screen having a coordinate system;
transforming, based on a starting point in the coordinate system, a section of the screen to which the starting point corresponds into a starting sub-screen;
selecting an ending point in the coordinate system, and transforming a section of the screen to which the ending point corresponds into an ending sub-screen;
selecting a plurality of midway points in the coordinate system, wherein the starting point, the midway points, and the ending point correspond to a time sequence;
transforming respectively sections of the screen to which the midway points correspond into a plurality of midway sub-screens; and
displaying sequentially the starting sub-screen, the midway sub-screens, and the ending sub-screen based on the time sequence.

9. The computer-readable medium of claim 8, wherein part or all of the screen is displayed concurrently with the starting sub-screen, the midway sub-screens, and the ending sub-screen being sequentially displayed.

10. The computer-readable medium of claim 9, wherein the starting sub-screen has a first resolution and the ending sub-screen has a second resolution.

11. The computer-readable medium of claim 8, wherein the screen has a first characteristic, and the starting sub-screen, the midway sub-screens, and the ending sub-screen have a second characteristic, wherein having the first characteristic is being wide-angle, having the second characteristic is being rectilinear, and the second characteristic arises from performing distortion correction of curvilinear imagery on the sections of the screen to which the starting point, the midway points, and the ending point respectively correspond.

12. The computer-readable medium of claim 8, wherein the time sequence has a plurality of time points, there is a fixed interval between any adjacent pair of the time points, and each of the starting point, the midway points, and the ending point corresponds to one of the time points.

13. The computer-readable medium of claim 8, wherein the screen includes a plurality of successive images of an identical field of view, and the starting sub-screen, the midway sub-screens, and the ending sub-screen respectively correspond to sections of the successive images of the screen.

14. The computer-readable medium of claim 8, wherein the starting point, the midway points, and the ending point correspond to the time sequence based on an easing curve.
